(19) United States
(12) Patent Application Publication
(10) Pub. No.: US 2006/0119249 A1
(43) Pub. Date: Jun. 8, 2006

(54) Flat-panel display

(75) Inventors: Motoyuki Miyata, Hitachinaka (JP); Hidenao Kubota, Yokohama (JP); Hiroyuki Akata, Hitachi (JP); Yoshie Kodera, Chigasaki (JP); Takashi Naito, Mito (JP); Katsuyuki Watanabe, Mito (JP); Hideto Momose, Hitachiota (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 11/067,320

(22) Filed: Feb. 24, 2005

(30) Foreign Application Priority Data
Dec. 6, 2004 (JP) 2004-352150

(51) Int. Cl. H01J 1/62; H01J 63/04

(52) U.S. Cl. 313/495

(57) ABSTRACT

An object of the present invention is to provide a flat-panel display using a glass material suitable for reducing thickness and weight thereof. According to the present invention, there is provided an image display panel including, two glass substrates and a light-emitting part provided between these glass substrates,

### INCORPORATION BY REFERENCE

The present application claims priority from Japanese application JP2004-352150 filed on Dec. 6, 2004, the content of which is hereby incorporated by reference into this application.

### BACKGROUND OF THE INVENTION

The present invention relates to a flat-panel display such as a plasma display using a plasma display panel. (PDP) or a field emission display.

A flat-panel display such as a plasma display or a field emission display is an image display device using a display panel composed of two opposed glass substrates and a light-emitting part provided between these glass substrates, as shown in FIG. 1.

In a plasma display, the display panel has a structure in which two glass substrates, in which numbers of linear electrodes are arranged, are placed such that the electrodes are opposed from each other, and gas is filled between the two glasses. Display electrodes that generate plasma discharge are formed in a front plate; partition walls for making discharge spaces are formed in a back plate; and a fluorescent material is coated on the inside of the back plate. A Xe-gas is sealed between the two substrates, and ultraviolet rays generated by plasma discharge generated between the display electrodes excite the fluorescent material to display RGB visible light.

In a field emission display, the display panel has, for example as disclosed in JP-A-2001-101965, a structure in which a back substrate and a display substrate are opposed to each other, wherein the back substrate has electron sources formed by arranging electron emitting elements composed of cold cathode elements in a matrix form on an insulating substrate and the display substrate has a fluorescent material that emits light by the collision of electrons from the electron sources on a light-transmitting substrate, and the periphery of the substrates is sealed to form an airtight vacuum state in the interior thereof. In addition, the spacing between the back substrate and the front substrate is maintained at a specified value by members (spacers) called partition walls, which are arranged in a display region such that they support these substrates.

Among flat-panel displays using these display panels, for example, a plasma display comprises a panel, an electric source, various circuits, a front filter and the like, as shown in FIG. 2.

The front filter is placed in front of the display panel for the purpose of adjusting optical properties thereof or protecting the same in terms of strength. On the other hand, for example, JP-A-2001-343898 discloses a plasma display with a structure in which a front filter is removed by forming a transparent conductive film or an AR film directly on the front glass substrate of the display panel. Although such a structure can reduce the thickness and weight of a plasma display, current glass substrate is not designed in adequate consideration of the strength such as impact resistance or the like in the case of removing the front filter.

A flat-panel display is expected for use as a wall-hung TV that can be easily installed at a low cost. However, the 32V-type monitor (except a stand) of a plasma display currently on the market has a weight of 24 kg, and construction work such as reinforcement of a wall is required for installing the plasma display on a wall of ordinary houses. Thus, it is necessary to further reduce the weight and thickness of a flat-panel display.

A glass substrate for use in the display panel for a flat-panel display requires high light transmittance, heat resistance, chemical stability, matching of the coefficient of thermal expansion with other members and the like. These requirements prevent the use of glass materials that have been subjected to strengthening treatment such as a chemically toughened glass, a crystallized glass and the like. Consequently, a specific thickness is required for securing a specific strength. This is a problem for the reduction in thickness and weight of a flat-panel display.

For example, in a plasma display, the weight of glass materials used for substrates and the like is about one third of the total weight. Thus, it is necessary to reduce the thickness and weight of glass materials for glass substrates and the like, in order to attempt the reduction in the weight of a plasma display.

Moreover, a field emission display requires, other than glass substrates, spacers, frame glasses for sealing the periphery and the like. It is necessary that these also have reduced weight and higher strength.

### SUMMARY OF THE INVENTION

An object of the present invention is to provide a flat-panel display with a reduced thickness and a reduced weight, by the investigation of glass materials.

Means for solving the above problem according to the present invention comprises a flat-panel display having a light emitting part between two substrates, or a flat-panel display comprising a display panel having a light emitting part between two substrates and a filter at a display surface side, characterized in that a glass material containing a specific rare-earth element is used for at least the substrates or the filter.

The present invention can provide a flat-panel display using a glass material that has a reduced thickness, a reduced weight and high strength.

Other objects, features and advantages of the invention will become apparent from the following description of the embodiments of the invention taken in conjunction with the accompanying drawings.

### BRIEF DESCRIPTION OF DRAWINGS

FIG. 1 is a cross-sectional view of a display panel;

FIG. 2 is a cross-sectional view of a flat-panel display;

FIG. 3 is a cross-sectional view of a flat-panel display; and

FIG. 4 is a cross-sectional view of a display panel.

### DESCRIPTION OF SYMBOLS

1 front plate
2 light-emitting part
3 back plate
4 front filter
5 display panel
6 casing
7 circuit
8 electric source
9 spread of RGB light emission
10 overlap of RGB light emission
11 RGB light-emitting source

### DETAILED DESCRIPTION OF THE INVENTION

The present invention specifically comprises an image display panel comprising at least two substrates and a light-emitting part provided between these substrates, or a flat-panel display using the display panel, characterized in that at least one of the substrates is a glass material that contains SiO₂ as a main component and contains at least one selected from the group consisting of La, Sc, Y, Ce, Pr, Nd, Pm, Sm, Eu, Gd, Tb, Dy, Ho, Er, Tm, Yb and Lu. Furthermore, the present invention specifically comprises an image display panel comprising at least two substrates and a light-emitting part provided between these substrates, or a flat-panel display using the display panel, characterized in that at least one of the substrates is a glass material that contains SiO₂ as a main component and contains at least one selected from the group consisting of La, Y, Gd, Yb and Lu.

The above described flat-panel display is characterized in that the composition of the above described glass material is, by weight in terms of the following oxides, from 40% to 80% of SiO₂, from 0% to 20% of B₂O₃, from 0% to 25% of Al₂O₃, from 5% to 20% of R₂O, where R denotes an alkali metal, from 5% to 25% of R′O, where R′ denotes an alkaline-earth metal, and from 1% to 20% of Ln₂O₃, where Ln denotes at least one selected from the group consisting of La, Sc, Y, Ce, Pr, Nd, Pm, Sm, Eu, Gd,. Tb, Dy, Ho, Er, Tm, Yb and Lu. Furthermore, the above described flat-panel display is characterized in that the composition of the above described glass material is, by weight in terms of the following oxides, from 50% to 70% of SiO₂, from 5% to 25% of Al₂O₃, from 7% to 20% of R₂O, where R denotes an alkali metal, and from 1% to 10% of Ln₂O₃, where Ln denotes at least one selected from the group consisting of La, Y, Gd, Yb and Lu.

The flat-panel display is characterized in that the above described glass material has a density of 2.6 g/cm³ or less.

The flat-panel display is characterized in that the above described glass material has a transition temperature of 450° C. or higher.

The flat-panel display is characterized in that the above described glass material has a transition temperature of 600° C. or higher.

The flat-panel display is characterized in that the above described glass material has a coefficient of thermal expansion of from 70×10⁻⁷/° C. to 90×10⁻⁷/° C.

The flat-panel display is characterized in that the above described glass material has a coefficient of thermal expansion of from 80×10⁻⁷/° C. to 90×10⁻⁷/° C.

The flat-panel display is characterized in that the above described glass material has a Young's modulus of 80 GPa or more, and has a specific Young's modulus obtained by dividing Young's modulus by density of 30 GPa/(g/cm³) or more.

The flat-panel display is characterized in that the above described glass material contains a coloring component.

The flat-panel display is characterized in that the above described glass substrate has a thickness of 2.5 mm or less.

The flat-panel display is characterized in that the above described glass substrate has a thickness of 2.0 mm or less.

The above described image display panel and the flat-panel display using the display panel are characterized in that the above described glass substrate is provided with a layer for adjusting electrical properties of a discharge electrode or the like and/or a layer for adjusting optical properties.

The above described image display panel and the flat-panel display using the display panel are characterized in that the above described glass substrate is provided with a layer for preventing scattering of glass when the glass substrate is broken.

The image display panel comprising, at least, two substrates and a light-emitting part provided between these substrates, and the flat-panel display using the display panel, are characterized in that the glass material described in any of the above is used for the front filter placed in front of the display panel.

The flat-panel display is characterized in that, in the above described front filter, the glass material is a laminate formed by laminating two or more sheets of glass material with a resin or the like.

### DESCRIPTION OF PREFERRED EMBODIMENT

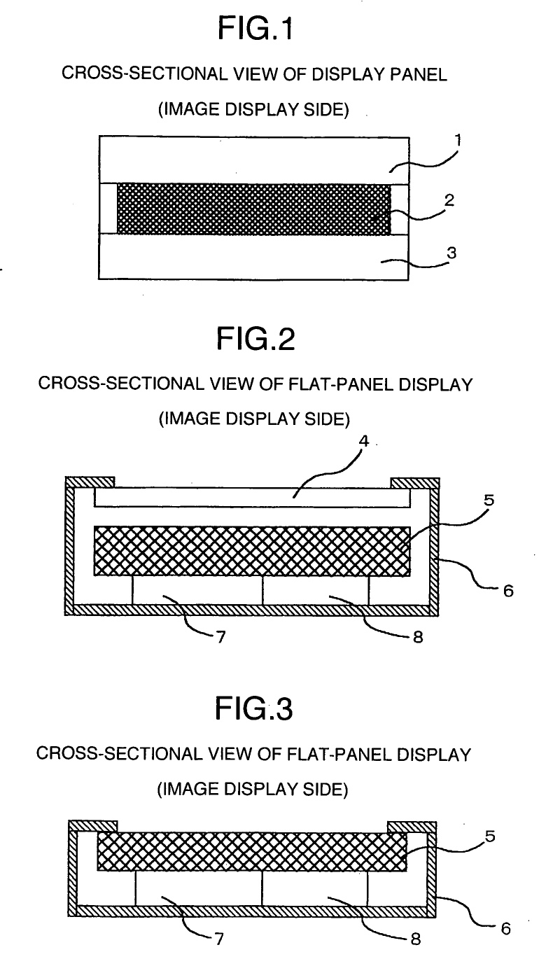

FIG. 1 shows a schematic drawing of a display panel, and FIG. 2 shows a schematic drawing of a plasma display. The plasma display is composed of a display panel, a circuit, an electric source and a front filter placed in front of the display panel. The plasma display according to the present invention can use a glass substrate with a smaller thickness than a conventional glass substrate (2.8 mm thick), which is used as a front plate and a back plate of the display panel. Thus, it becomes possible to reduce the weight and thickness of a flat-panel display.

A field emission display is composed of a front substrate and a back substrate which are opposingly arranged to each other, spacers arranged between these substrates, frame glasses arranged at the peripheral edge of the substrates and the like. Similar to the case of a plasma display, it is possible to reduce the thickness and weight of the front substrate and back substrate by using the glass material according to the present invention. Moreover, the spacers, although the size thereof depends on the spacing for installing electron sources, are required to have a shape with a height of several millimeters and a width of several 100 μm, that is, an extremely thin shape with a large aspect ratio. In order to use a glass material of a shape as described above stably for a long period of time under a vacuum environment where compression stress acts, it is necessary to increase the strength of the glass material itself. In this respect, the material according to the present invention, which has higher strength than conventional materials as described below, is extremely effective as a material for spacers.

Moreover, as shown in FIG. 3, a structure requiring no front filter can be formed for both a plasma display and a field emission display by increasing the strength of glass substrates. This can further reduce the thickness and weight of a flat-panel display. Even in such a structure with no front filter, use of a glass material according to the present invention allows a layer for adjusting electrical properties, a layer for adjusting optical properties and the like, which are conventionally formed on the front filter, to be formed on a front plate of the display panel. Further, as an insurance against a possible breakage of glass substrates, it is possible to form a layer for preventing scattering of glass due to the breakage. Furthermore, even in the case a front filter is required for some applications, use of a glass material according to the present invention as a front filter allows reduction in the thickness of the front filter, and thereby the reduction in the thickness and weight of a flat-panel display can be achieved.

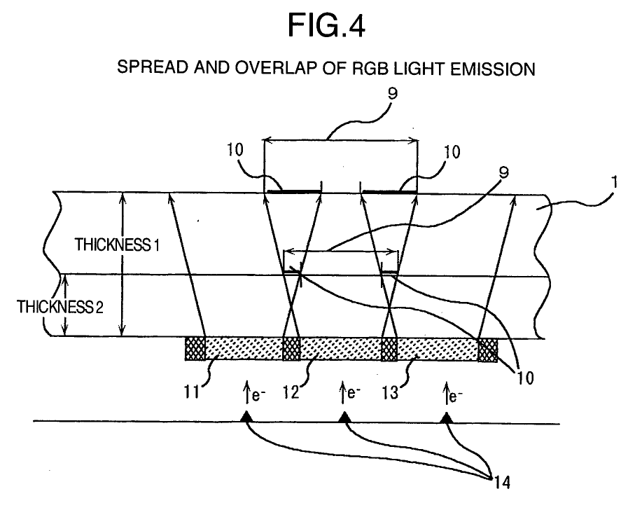

Moreover, the advantage of a thickness reduction may include, other than the above described weight reduction, the improvement of display performance of a flat-panel display. As shown in FIG. 4, it is possible to reduce the level of spread of RGB light emission emitted from a light-emitting part of a display panel and the size of overlap regions of RGB light emissions by reducing the thickness of a glass material, and thereby higher definition of a flat-panel display can be achieved. The amount of the reduction in spread and overlap regions of the RGB light emission varies depending on a refractive index, thickness and the like of a glass material. When the refractive index is the same, the size of the spread and overlap regions can be reduced to approximately one-half by reducing the thickness of the glass material to one-half.

A glass material according to the present invention will now be described. A commercial large-size glass substrate with a size of one meter square is made, for example, by a float process. However, a method of making an experimental material for evaluating various properties of a glass material will be described below. A predetermined amount of raw material powder was weighed into a platinum crucible, mixed and melted in an electric furnace at 1,600° C. After the raw material is sufficiently melted, a platinum stirring blade was inserted into the glass melt to stir the same for about 40 minutes. After the stirring blade was removed, the glass melt was left at rest for 20 minutes and then poured into a graphite container heated to about 400° C. to be rapidly cooled to form a glass block. Then, the block was reheated to the vicinity of the glass transition temperature of each glass followed by slow cooling at a cooling speed of from 1 to 2° C./minute to relieve internal stress.

Micro-Vickers hardness (Hv) was measured at 10 points under conditions of a measuring load of 500 g and a load application time of 15 seconds, and the measured values were averaged. The measurement was performed after a lapse of 20 minutes from the time of the load application. The dimension of the specimen was 4 mm×4 mm×15 mm. Transmittance was measured using a spectrophotometer in a visible wavelength region (380 to 770 nm) from the intensity ratio of the incident light perpendicular to the glass to the transmitted light. The dimension of the specimen was 15 mm×25 mm×1 mm.

Table 1 shows the composition of the glass materials studied in the present invention and micro-Vickers hardness (Hv).

TABLE 1

| | Mixing ratio (by weight) | | | | | | | | | | | | | |
|---|---|---|---|---|---|---|---|---|---|---|---|---|---|---|
| No. | SiO₂ | B₂O₃ | Al₂O₃ | Na₂O | Li₂O | K₂O | CaO | MgO | SrO | ZrO₂ | BaO | ZnO | Yb₂O₃ | Hv |
| 1 | 62.0 | 9.0 | 10.5 | 6.7 | 3.8 | 2.0− | | 6.0 | — | — | — | — | 0.0 | 535 |
| 2 | 62.0 | 9.0 | 10.5 | 6.7 | 3.8 | 2.0− | | 6.0 | — | — | — | — | 0.5 | 540 |
| 3 | 62.0 | 9.0 | 10.5 | 6.7 | 3.8 | 2.0− | | 6.0 | — | — | — | — | 1.0 | 571 |
| 4 | 62.0 | 9.0 | 10.5 | 6.7 | 3.8 | 2.0− | | 6.0 | — | — | — | — | 3.1 | 583 |
| 5 | 62.0 | 9.0 | 10.5 | 6.7 | 3.8 | 2.0− | | 6.0 | — | — | — | — | 5.3 | 605 |
| 6 | 62.0 | 9.0 | 10.5 | 6.7 | 3.8 | 2.0− | | 6.0 | — | — | — | — | 12.0 | 628 |
| 7 | 62.0 | 9.0 | 10.5 | 6.7 | 3.8 | 2.0− | | 6.0 | — | — | — | — | 18.0 | 646 |
| 8 | 62.0 | 9.0 | 10.5 | 6.7 | 3.8 | 2.0− | | 6.0 | — | — | — | — | 25.0 | 666 |
| 9 | 62.0 | 9.0 | 10.5 | 6.7 | 3.8 | 2.0− | | 6.0 | — | — | — | — | 45.0 | — |
| 10 | 56.5 | 11.0 | 14.0 | 6.7 | 3.8 | 2.0− | | 6.0 | — | — | — | — | 0.0 | 553 |
| 11 | 71.0 | 4.0 | 6.5 | 6.7 | 3.8 | 2.0− | | 6.0 | — | — | — | — | 0.0 | 542 |
| 12 | 56.5 | 11.0 | 14.0 | 6.7 | 3.8 | 2.0− | | 6.0 | — | — | — | — | 5.3 | 572 |
| 13 | 71.0 | 4.0 | 6.5 | 6.7 | 3.8 | 2.0− | | 6.0 | — | — | — | — | 5.3 | 548 |
| 14 | 64.0 | — | 16.0 | 7.5 | 3.5− | 1 | .0 | 7.0 | — | 1.0− | | — | 0.0 | 593 |
| 15 | 64.0 | — | 16.0 | 7.5 | 3.5− | 1 | .0 | 7.0 | — | 1.0− | | — | 3.1 | 635 |
| 16 | 64.0 | — | 16.0 | 7.5 | 3.5− | 1 | .0 | 7.0 | — | 1.0− | | — | 5.3 | 655 |
| 17 | 64.0 | — | 16.0 | 7.5 | 3.5− | 1 | .0 | 7.0 | — | 1.0− | | — | 12.0 | 676 |
| 18 | 64.0 | — | 16.0 | 7.5 | 3.5− | 1 | .0 | 7.0 | — | 1.0− | | — | 25.0 | 697 |
| 19 | 72.5 | — | 1.5 | 14.0 | — | −8 | .0 | 4.0 | — | — | — | — | 0.0 | 491 |
| 20 | 72.5 | — | 1.5 | 14.0 | — | −8 | .0 | 4.0 | — | — | — | — | 3.1 | 536 |
| 21 | 72.5 | — | 1.5 | 14.0 | — | −8 | .0 | 4.0 | — | — | — | — | 5.3 | 559 |
| 22 | 72.5 | — | 1.5 | 14.0 | — | −8 | .0 | 4.0 | — | — | — | — | 12.0 | 577 |
| 23 | 72.5 | — | 1.5 | 14.0 | — | −8 | .0 | 4.0 | — | — | — | — | 18.0 | 588 |
| 24 | 72.5 | — | 1.5 | 14.0 | — | −8 | .0 | 4.0 | — | — | — | — | 25.0 | 594 |
| 25 | 60.0 | — | 7.0 | 4.0− | | 6.0 | 4.5 | 2.0 | 7.0 | 2.5 | 7.0− | | 0.0 | 577 |
| 26 | 60.0 | — | 7.0 | 4.0− | | 6.0 | 4.5 | 2.0 | 7.0 | 2.5 | 7.0− | | 3.1 | 601 |
| 27 | 60.0 | — | 7.0 | 4.0− | | 6.0 | 4.5 | 2.0 | 7.0 | 2.5 | 7.0− | | 5.3 | 623 |
| 28 | 60.0 | — | 7.0 | 4.0− | | 6.0 | 4.5 | 2.0 | 7.0 | 2.5 | 7.0− | | 12.0 | 644 |
| 29 | 60.0 | — | 7.0 | 4.0− | | 6.0 | 4.5 | 2.0 | 7.0 | 2.5 | 7.0− | | 18.0 | 668 |
| 30 | 60.0 | — | 7.0 | 4.0− | | 6.0 | 4.5 | 2.0 | 7.0 | 2.5 | 7.0− | | 25.0 | 689 |
| 31 | 63.0 | — | 3.0 | 2.0− | | 10.0 | 3.5 | 6.5 | 11.0 | −1 | .0− | | 0.0 | 556 |
| 32 | 63.0 | — | 3.0 | 2.0− | | 10.0 | 3.5 | 6.5 | 11.0 | −1 | .0− | | 3.1 | 583 |
| 33 | 63.0 | — | 3.0 | 2.0− | | 10.0 | 3.5 | 6.5 | 11.0 | −1 | .0− | | 5.3 | 602 |
| 34 | 63.0 | — | 3.0 | 2.0− | | 10.0 | 3.5 | 6.5 | 11.0 | −1 | .0− | | 12.0 | 633 |
| 35 | 63.0 | — | 3.0 | 2.0− | | 10.0 | 3.5 | 6.5 | 11.0 | −1 | .0− | | 18.0 | 648 |
| 36 | 63.0 | — | 3.0 | 2.0− | | 10.0 | 3.5 | 6.5 | 11.0 | −1 | .0− | | 25.0 | 665 |
| 37 | 65.0 | — | 16.0 | 4.0 | 9.0 | 1.0− | | — | — | — | — | 2.0 | 0.0 | 556 |
| 38 | 65.0 | — | 16.0 | 4.0 | 9.0 | 1.0− | | — | — | — | — | 2.0 | 3.1 | 595 |
| 39 | 65.0 | — | 16.0 | 4.0 | 9.0 | 1.0− | | — | — | — | — | 2.0 | 5.3 | 618 |
| 40 | 65.0 | — | 16.0 | 4.0 | 9.0 | 1.0− | | — | — | — | — | 2.0 | 12.0 | 633 |
| 41 | 65.0 | — | 16.0 | 4.0 | 9.0 | 1.0− | | — | — | — | — | 2.0 | 18.0 | 648 |
| 42 | 65.0 | — | 16.0 | 4.0 | 9.0 | 1.0− | | — | — | — | — | 2.0 | 25.0 | 665 |

Glass No. 1 is an aluminoborosilicate glass containing SiO₂, Al₂O₃ and B₂O₃ as main components. The composition of this glass was used as the basic composition, and a predetermined amount of a rare earth oxide was added to 100 parts by weight of this glass. Nos. 2 to 8 in Table 1 represent different glasses in each of which ytterbium oxide (Yb₂O₃), which is one of rare earth oxides, in an amount ranging from 0.5 to 25 parts by weight was added to 100 parts by weight of Glass No. 1. No. 9 represents a glass in which 45 parts of ytterbium oxide is added to 100 parts by weight of Glass No. 1. However, the raw material powder of Yb₂O₃ remained in the glass during glass melting, and it was difficult to obtain a homogeneous glass. No. 10 and No. 11 represent glasses that have been made by varying the added amount of SiO₂, Al₂O₃ and B₂O₃ to 100 parts by weight of Glass No. 1. Glass No. 12 is made by adding 5.3 parts by weight of Yb₂O₃ to 100 parts by weight of Glass No. 10, and Glass No. 13 is made with 5.3 parts of Yb₂O₃ to 100 parts of Glass No. 11.

No. 14 represents an aluminosilicate glass containing SiO₂ and Al₂O₃ as main components. Nos. 15 to 18 represent different glasses in each of which Yb₂O₃ in an amount ranging from 3.1 to 25 parts by weight was added to 100 parts by weight of Glass No. 14.

Nos. 20 to 24 represent different glasses in each of which Yb₂O₃ in an amount ranging from 3.1 to 25 parts by weight was added to 100 parts by weight of Glass No. 19. Nos. 26 to 30 represent different glasses in each of which Yb₂O₃ in an amount ranging from 3.1 to 25 parts by weight was added to 100 parts by weight of Glass No. 25. Nos. 32 to 36 represent different glasses in each of which Yb₂O₃ in an amount ranging from 3.1 to 25 parts by weight was added to 100 parts by weight of Glass No. 31. Nos. 38 to 42 represent different glasses in each of which Yb₂O₃ in an amount ranging from 3.1 to 25 parts by weight was added to 100 parts by weight of Glass No. 37.

Table 2 shows properties of glasses chemically toughened by exchanging alkali ions as Comparative Examples.

Here, Nos. 43, 44, 45, 46, 47 and 48 represent glasses made by subjecting chemical toughening to Glass Nos. 1, 14, 19, 25, 31 and 37, respectively.

TABLE 2

| No. | Hv |
|---|---|
| 43 | 572 |
| 44 | 630 |
| 45 | 530 |
| 46 | 600 |
| 47 | 580 |
| 48 | 585 |

The chemical toughing was performed by immersing a glass processed to a flat plate with a thickness of about 1.0 mm in a solution of potassium nitrate at 380° C. for 40 minutes. The thickness of a chemically toughened layer was about 10 μm. As shown in Table 2, it was found that chemically touched glasses had a Hv of about 4% to 8% higher than the respective glasses before toughening.

The glass strengths shown in Table 1 are evaluated based on the Hv values of the chemically toughened glasses. The glasses of Nos. 2 to 8 were evaluated as follows: No. 2, in which 0.5 parts by weight of Yb₂O₃ was added to 100 parts by weight of Glass No. 1, had a higher micro-Vickers hardness than that of Glass No. 1, but the increase was smaller than that of No. 43, that is, the hardness of No. 2 was lower than that of a chemically toughened glass; No. 4, in which 3.1 parts by weight of Yb₂O₃ was added to 100 parts by weight of Glass No. 1, had an Hv value exceeding that of the chemically toughened glass No. 43; and the glasses of Nos. 5 to 8, in which the addition amount of Yb₂O₃ was further increased, each had a further increased Hv. As described above, it was possible to largely increase Hv by adding Yb₂O₃. Similar results were obtained for the glasses of Nos. 44, 45, 46, 47 and 48 which were made by subjecting the glasses of Nos. 14, 19, 25, 31 and 37 to chemical toughening, respectively.

Moreover, as shown in Nos. 10 to 13, addition of Yb₂O₃ was more effective to increase Hv than variation of the contents of components, such as SiO₂ and Al₂O₃, likely to improve other mechanical strengths. In a series of the glasses Nos. 14 to 18 as well as in another series of the glasses Nos. 19 to 24, which have basic glass compositions different from the glasses Nos. 10 to 13, the mechanical property was improved by the addition of Yb₂O₃ as in the glasses of Nos. 10 to 13.

Next, Glass No. 1, Glass No. 4 and for comparison the chemically toughened glass No. 43 were tested for three-point bending strength. Table 3 shows the average value of the three-point bending strength (σ/MPa)

TABLE 3

| No. | N | σ (MPa) |
|---|---|---|
| 1 | 20 | 331 |
| 5 | 20 | 398 |
| 43 | 20 | 388 |

The evaluation was performed using a specimen with a glass thickness of 1.0 mm, a width of 4 mm and a length of 40 mm. The span length was set at 30 mm. The number of specimens was 20 for each sample. The three-point bending strength σ (MPa) is calculated by the expression:
σ=(3lw/2at²)
where w denotes a load applied; l denotes a span length; a denotes the width of a specimen; and t denotes the thickness of a specimen.

Glass No. 1 had an average three-point bending strength of 153 MPa. Glass No. 5 had an average three-point bending strength of 232 MPa, which was about 50% higher than that of Glass No. 1 and similar to that of a chemically toughened glass.

Table 4 shows light transmittance of the glasses of Nos. 2 to 8. As shown here, all of the glasses had a value of higher than 80%.

TABLE 4

| No. | Transmittance (%) |
|---|---|
| 2 | 92.4 |
| 3 | 92.2 |
| 4 | 92.0 |
| 5 | 92.0 |
| 6 | 90.8 |
| 7 | 84.7 |
| 8 | 80.5 |

Next, different glasses were made by adding 4 parts by weight of each of different rare earth element oxides to 100 parts by weight of Glass No. 1. Table 5 shows types of the rare earth elements added and micro-Vickers hardness and light transmittance of the obtained glasses.

TABLE 5

| No. | Ln | Hv | Transmittance (%) |
|---|---|---|---|
| 49 | Y | 558 | 92 |
| 50 | La | 555 | 92 |
| 51 | Pr | 591 | 78 |
| 52 | Nd | 591 | 60 |
| 53 | Sm | 593 | 81 |
| 54 | Eu | 587 | 90 |
| 55 | Gd | 583 | 92 |
| 56 | Dy | 601 | 90 |
| 57 | Ho | 590 | 68 |
| 58 | Er | 590 | 70 |
| 59 | Tm | 590 | 90 |
| 60 | Yb | 590 | 92 |
| 61 | Lu | 593 | 91 |

It was found that Micro-Vickers hardness increased in all the cases where any rare earth element was added. In particular, the extent of the increase was higher in the case where so called heavy rare earth elements were added. The hardness values in the case of adding heavy rare earth elements were higher than 580, which were higher than Hv of a chemically toughened glass. The glasses of Nos. 49, 50, 54, 55, 56, 59, 60 and 61 had a transmittance of 90% or higher.

It is particularly desirable that the glass material itself, which is used in the side for displaying images as a front plate or a front filter, have a light transmittance as high as possible. In this respect, the glass materials of Nos. 42, 43, 47, 48, 49, 52, 53 and 54, which showed high transmittance, are suitable for front plates and front filters. However, for example in a plasma display, a MBP (Multi Band Pass) color filter is formed as a front filter in order to correct color of images to be displayed. Actually, this filter itself reduces light transmittance to some extent. Therefore, a glass material with a transmittance of less than 90% can also be used by adjusting properties of the filter.

In PDP, ultraviolet rays are generated at a light emitting part thereof to stimulate a fluorescent material for RGB light emission. If a part of the ultraviolet rays generated reaches a front plate to cause light emission of the front plate itself, the light emission may adversely affect the quality of images to be displayed. When the glass materials in Table 5 were exposed to ultraviolet rays (with a wavelength of 265 nm), those containing Y, La, Gd, Yb or Lu did not exhibit light emission by ultraviolet rays. Consequently, Y, La, Gd, Yb and Lu are preferred among the rare earth elements to be added.

As shown in Table 1, when the content of a rare earth oxide exceeds 20% by weight, mechanical properties dropped due to formation of insolubles or lack of homogeneity in glass. These phenomena are not preferable. Moreover, when the content is less than 1% by weight, the effect in improving mechanical strength was small. Consequently, the content of a rare earth oxide is preferably from 1% to 20% by weight. However, when the content exceeded 10% by weight, the glass material started to be devitrified to reduce light transmittance. Thus, the content of a rare earth oxide is more preferably from 1% to 10% by weight.

Next, the composition of a base glass was studied. A SiO₂ content of less than 40% by weight was not preferable due to the reduction of mechanical strength and chemical stability. On the other hand, when the SiO₂ content exceeded 80% by weight, melt properties reduced to generate numbers of striae. Therefore, the SiO₂ content is preferably from 40% to 80% by weight, more preferably from 50% to 70% by weight.

When B₂O₃ was added to a base glass, a glass with excellent flowability was obtained. However, when the content exceeded 20% by weight, the effect in the improvement of mechanical strength by containing a rare earth was reduced. Consequently, the content of B₂O₃ is preferably 20% by weight or less. However, when B₂O₃ is mixed with an alkali metal oxide, evaporation of the alkali metal is facilitated during the melting of glass. This may hurt a wall material of a melting furnace, causing cost increase. Preferably, B₂O₃ is not mixed with an alkali metal oxide, particularly in the stage of mass production.

Next, alkali metal oxides were studied. When the sum of the content of alkali metal oxides (Li₂O, Na₂O, K₂O) exceeded 20% by weight, chemical stability reduced. Addition of alkali metal oxides acts to increase the coefficient of thermal expansion of glass materials. Therefore, the sum of the content of alkali metal oxides is preferably from 5% to 20% by weight, more preferably from 7% to 20% by weight. In the case of alkaline-earth metal oxides, the content thereof exceeding 25% by weight reduced chemical stability. Similar to alkali metal oxides, addition of alkaline-earth metal oxides also acts to increase the coefficient of thermal expansion of glass materials. Further, alkaline-earth metal oxides reduce the transition point of glass materials less than alkali metal oxides. Consequently, the content of alkaline-earth metal oxides is preferably from 5% to 25% by weight.

Moreover, alkali metal oxides and alkaline-earth metal oxides showed similar effect in terms of reducing melting point of glass. However, when the sum of the content thereof is less than 5% by weight, the flowability was poor and numbers of striae appeared. Further, when it exceeds 40% by weight, chemical stability reduced. Consequently, the sum of the content of alkali metal oxides and alkaline-earth metal oxides is preferably from 5% to less than 40% by weight.

Al₂O₃ was effective in increasing mechanical strength and chemical stability of glass. The effect was remarkable when the content of Al₂O₃ was 5% by weight or more. However, the content exceeding 25% by weight undesirably reduced the flowability of glass. Consequently, the content of Al₂O₃ is preferably 25% by weight or less, more preferably from 5% to 25% by weight.

Furthermore, ZnO, ZrO₂ and the like can be added other than the above described oxides.

Addition of ZnO is effective in facilitating melting of glass and improving durability of glass. In particular, when the content is 0.5% by weight or higher, the effect is desirably more remarkable. However, when the content exceeds 10% by weight, the devitrification of glass is increased and a glass with high homogeneity cannot be obtained.

Addition of ZrO₂ is effective in improving durability of glass. In particular, when the content ranges from 0.5% to 5% by weight, the effect is desirably more remarkable. However, when the content exceeds 5% by weight, the melting of glass becomes difficult and the devitrification of glass is increased.

Moreover, a glass material according to the present invention is preferably subjected to etching with hydrofluoric acid, fluoronitric acid, fluorosulfuric acid, buffered hydrofluoric acid or the like at the end surfaces of its periphery and chamfered surfaces in order to remove fine scratches due to processing. The etching can improve bending strength of the material by at least about 30%. In particular, when the glass containing a rare earth oxide as a glass component is subjected to the etching, it can obtain a very high strength.

A glass material according to the present invention has a sufficient strength by adding a rare earth element. Therefore, the glass does not require surface toughening treatment such as chemical toughening which is a conventional toughening method of a glass material. Specifically, the glass is characterized in that the glass surface has no compression toughened layer in which residual stress is generated. The presence of absence of the compression toughened layer in the surface can be determined, for example, by a method in which the surface is irradiated with a laser beam and the reflected light is separated with a prism. When a glass material according to the present invention was evaluated by the above described method, it was confirmed that the difference between the residual stress in the inside of the glass and that in the surface was almost zero, that is, there was no surface stress layer.

A glass according to the present invention is characterized in that there is no compression toughened layer in the surface thereof and a stress distribution inside the glass is substantially uniform. As a result, even when the surface of a glass according to the present invention has a flaw that has a depth comparable to that of a compression toughened layer of a chemically toughened glass, the whole of the inventive glass will not break into pieces like a chemically toughened glass.

Moreover, in a chemically toughened glass, a compression toughened phase formed in the surface thereof is balanced with a tension phase formed in the inside thereof. Consequently, when the glass is required to have a specific strength, the thickness of the glass is limited depending on the strength. On the other hand, since a glass material according to the present invention does not need to have a surface stress layer, there is no thickness limitation as in the case of a chemically toughened glass, and it is possible to make a thinner glass. Conventional glass substrates need to have a thickness of about 2.8 mm in order to ensure sufficient mechanical strengths. However, since a glass material is toughened without special toughening treatment in the glass according to the present invention, the thickness of the glass substrate can be made thinner than that of conventional materials, and thereby the thickness of a flat-panel display can be reduced.

In a display panel and a flat-panel display according to present invention, the thickness of a glass substrate can be reduced, and thereby the weight of a glass material, in turn the weight of a display panel and a flat-panel display, can be reduced. However, if the density of a glass material becomes higher, the effect in the weight reduction due to the reduction in the thickness of a glass substrate will be smaller. Therefore, a glass material preferably has a density of 2.8 g/cm³ or less, more preferably 2.6 g/cm³ or less.

A glass material according to the present invention preferably has a transition temperature of 450° C. or higher, more preferably 600° C. or higher. This is due to the reason as described below. In a production process, a display panel is subjected to heat treatment in which it is heated to elevated temperatures, in steps such as a joining step and a vacuum discharge step. If the transition temperature of a glass material is lower than the maximum temperature in a heat treatment step that is actually adopted or assumed in processes for producing various display panels, residual stress may be generated in a glass substrate, leading to deficiency or breakage of a display panel.

A glass material according to the present invention preferably has a coefficient of thermal expansion of from 70×10⁻⁷/° C. to 90×10⁻⁷/° C., more preferably from 80×10⁻⁷/° C. to 90×10⁻⁷/° C. in relation to the coefficient of thermal expansion of other members such as a sealing glass material. This is due to the reason that a coefficient of thermal expansion that is larger or smaller than the above described values will generate residual stress in the vicinity of a joining part caused by the difference of the coefficient of thermal expansion, leading to deficiency or breakage of a panel.

A glass material according to the present invention preferably has a Young's modulus of 80 GPa or more, and has a specific Young's modulus (a value obtained by dividing Young's modulus by density) of 30 GPa/(g/cm³) or more. This is due to the reason that, if values of Young's modulus and specific Young's modulus are smaller than the above described values, deformation of a glass substrate may be larger, leading to the deterioration in handling properties which in turn may cause problems in production steps and a yield.

In the present invention, the reduction in thickness and weight of a flat-panel display can be expected, because the thickness of a glass substrate can be smaller than that of current materials without largely changing the density of a glass material compared to that of conventional glass substrate materials. Moreover, a reduction in time, labor and cost for carrying and installing a flat-panel display can be expected by reducing the weight of the display. Specifically, the flat-panel display can be directly installed on a wall or the like.

Particularly in the case of a current plasma display, the proportion of a glass material in the weight of a monitor is about 35%. A reduction in the thickness of a glass substrate allows the above proportion to be reduced as well as allows the weight of the display to be reduced.

The weight of glass substrates (two pieces) can be reduced by more than 20%, actually about 21%, of the current weight by using a thinner glass substrate thickness of 2.5 mm, and can be further largely reduced by 57% of the current weight by using a thinner thickness of 2.0 mm. Therefore, a glass substrate preferably has a thickness of 2.5 mm or less, more preferably 2.0 mm or less.

A glass material according to the present invention can be made as a glass with a small thickness per piece because of a special toughing mechanism. Therefore, when it is particularly used for applications requiring strength, it is possible to further increase strength by laminating two or more glasses through resin. The reliability of a flat-panel display can be further improved by using such a laminate glass as a front filter. However, since the total weight of glass materials increases in proportion to the number of laminated glasses, the total thickness of the laminated glass materials is desirably the same or less as that of a one-piece material so that the laminate does not have excessive weight.

Further, in the case of this laminated glass material, it is possible to further increase strength by placing a wire of metal, ceramics, carbon fibers, glass fibers or the like, in a resin layer, when glass lamination is performed.

Furthermore, a wire of metal, ceramics or the like may also be placed in a glass, as a method for placing a wire in the above described glass material. In this case, a wired glass plate can be made by inserting a wire of heat resistant metal, ceramics or the like while a glass raw material is in a molten state at a high temperature followed by cooling and solidification of the glass raw material. Prevention of falling and scattering of broken glass pieces due to collision of heavy objects can be expected by placing a wire in the above described transparent glass. This is particularly suitable for a flat-panel display to be installed in the outdoors.

A glass material of the present invention can be colored by containing various elements. Coloring elements, which are components absorbing visible light (380 to 780 nm), include iron, cobalt, nickel, chrome, manganese, vanadium, selenium, copper, gold, silver and the like, other than rare earth elements. It is possible to improve contrast of a flat-panel display by coloring a glass material by adding a suitable amount of any of these coloring elements depending on applications.

Next, the glasses Nos. 1, 4, 5 and 7 in Example and the chemically toughened glass No. 37 as Comparative Example were evaluated for water resistance, heat resistance and surface roughness. The size of the specimens of glass substrates which were made was 75 mm×25 mm×1.0 mm. Table 6 shows the water resistance, heat resistance and surface roughness of the obtained substrates.

TABLE 6

| | Water resistance, | | |
|---|---|---|---|
| | alkali concentration | | |
| No. | (ppm) | Heat resistance | Ra (nm) |
| 1 | 5.0 | good | 0.6 |
| 4 | 2.0 | good | 0.1 |
| 5 | 2.0 | good | 0.2 |
| 7 | 2.0 | good | 0.3 |
| 43 | 11.0 | Poor | 0.9 |

For evaluating water resistance, a substrate was immersed in 80 ml of pure water at 70° C. for 20 hours; total amount of alkali and alkaline-earth elements eluted in pure water was detected; and total amount of the elution was shown in Table 6 in ppm. As for heat resistance, a substrate was heated to 350° C. in vacuum, and then the surface thereof was subjected to secondary ion mass spectrometry. A substrate in which diffusion of alkali ions was observed in the surface layer thereof was rated as poor, and that in which the diffusion was not observed was rated as good.

In terms of water resistance, the glasses Nos. 4, 5 and 7 showed less alkali elution amount than the chemically toughened glass No. 37. In the heat resistance test, a high amount of alkali elements was detected in the surface layer of the chemically toughened glass No. 37, showing the movement of the ions. As described above, alkali elements easily move in the chemically toughened glass, which shows the instability of glass. On the other hand, the inventive glass substrate showed good thermal and chemical stability.

As for surface roughness, the glass substrates Nos. 4, 5 and 7 showed a good smoothness of an Ra of 0.1 nm to 0.3 nm. The surface roughness after the water resistance test also showed a high smoothness of an Ra of 0.2 nm to 0.4 nm. On the other hand, Glass No. 37 showed an Ra of 0.9 nm, and showed a larger value of an Ra of 1.5 nm after the water resistance test. Moreover, all the inventive glass substrates tested showed better results than Glass No. 1 that contains no rare earth oxide. As described above, the inventive materials are better in chemical stability than No. 1 and No. 37. Therefore, when a transparent conductive film and an antireflection film are formed on the glass material, these films are excellent in stability with time. In addition, similar results were also obtained for glass materials No. 10 through No. 36.

Next, resistance to high temperature and humidity was tested for simulating weatherability of a glass substrate. Glass No. 4 in Example and the. chemically toughened glass No. 37 as Comparative Example were placed under an environment of a temperature of 85° C. and a humidity of 85% for observing the possible change thereof. The chemically toughened glass of Comparative Example showed surface whitening at a time point of 500 hours after starting the test, but Glass No. 4 in Example did not show any particular change.

It is considered that alkali elements in glass move to the glass surface due to environmental humidity and is precipitated to form surface whitening. If the whitening occurs in a glass substrate material in the display side, it will cause images to be displayed to deteriorate. Since alkali elements in glass easily move to a glass surface in a chemically toughened glass, the whitening will easily occur. On the other hand, since alkali elements in glass will not easily move to a glass surface in the inventive glass, the whitening will not occur easily. Thus, high weatherability of the inventive glass can be expected.

As shown in FIG. 3, in the case of a structure without a front filter, a layer for adjusting electrical properties and a layer for adjusting optical properties as well as a layer for preventing scattering of glass due to breakage in preparation for possible breakage of a glass substrate are formed in a front plate of the display panel. When these layers are formed on the surface of the inventive glass material, advantageously, separation and quality deterioration of these layers will not easily occur, since as described above alkali components will not easily move to the glass surface in the glass material according to the present invention.

When a flat-panel display is installed in the outdoors, contaminants will naturally adhere to the surface thereof by leaving the display to stand for a long period of time. As a result, there is apprehension that the performance of image display deteriorates. Formation of a photocatalyst layer on the surface of a glass allows the cleanness of the surface to be easily maintained because the contamination adhered to the glass surface is decomposed by the action of light energy, together with the cleaning effect at the time of rainfall. As a result, the deterioration of the performance of image display can be suppressed.

When a conventional chemically toughened glass is used for the formation of a photocatalyst layer thereon, the photocatalyst layer is apt to be separated from the surface of the glass due to the movement of alkali elements from inside the glass. On the other hand, when the inventive glass is used, the photocatalyst layer is hard to be separated, since alkali elements in the inventive glass are hard to move to the surface of the glass, and as described in Table 6, the amount of eluted alkali can be reduced to one fifth of a chemically toughened glass. Consequently, the photocatalyst layer on the inventive glass is hard to be separated and can be easily maintained for a long period of time that is five times or more longer than in the case of a chemically toughened glass.

It should be further understood by those skilled in the art that although the foregoing description has been made on embodiments of the invention, the invention is not limited thereto and various changes and modifications may be made without departing from the spirit of the invention and the scope of the appended claims.

1. A flat-panel display comprising:
two substrates; and
a light-emitting part provided between said substrates,
wherein at least one of said substrates is a glass material that contains SiO₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

2. A flat-panel display comprising:
two substrates; and
a light-emitting part provided between said substrates, wherein at least one of said substrates is a glass material that contains SiO₂ as a main component and contains from 1% to 10% by weight of at least one selected from a group consisting of La, Y, Gd, Yb and Lu.

3. A flat-panel display comprising:
an image display panel comprising two substrates and a light-emitting part provided between said substrates; and
a filter provided at a display surface side of said image display panel,
wherein said filter is a glass material that contains Sio₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

4. A flat-panel display comprising:
an image display panel comprising two substrates and a light-emitting part provided between said substrates; and
a filter provided at a display surface side of said image display panel,
wherein said filter is a glass material that contains SiO₂ as a main component and contains from 1% to 10% by weight of at least one selected from a group consisting of La, Y, Gd, Yb and Lu.

5. The flat-panel display according to claim 3 or 4, wherein said front filter is a laminate formed by laminating two or more sheets of glass material through an adhesive layer.

6. A flat-panel display comprising a vacuum container comprising:
a back substrate that comprises an electron source array on an inside surface thereof;
a front substrate that comprises a fluorescent-material pattern and accelerating electrodes formed in an array corresponding to said electron source array on an inside surface thereof, with an outside surface thereof being used as a display surface, wherein the inside surface of said back substrate and the inside surface of said front substrate are opposed to each other; and
a sealing part for sealing the peripheral edges of said substrates through a sealing material,
wherein at least one of said substrates is a glass material that contains SiO₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

7. A flat-panel display comprising a vacuum container comprising:
a back substrate that comprises an electron source array on an inside surface thereof; and
a front substrate that comprises a fluorescent-material pattern and accelerating electrodes formed in an array corresponding to said electron source array on an inside surface thereof, with an outside surface thereof being used as a display surface, wherein the inside surface of said back substrate and the inside surface of said front substrate are opposed to each other; and
a sealing part for sealing a peripheral edge of said substrates through a sealing material;
wherein at least one of said substrates is a glass material that contains SiO₂ as a main component and contains from 1% to 10% by weight of at least one selected from a group consisting of La, Sc, Y, Ce, Pr, Nd, Pm, Sm, Eu, Gd, Tb, Dy, Ho, Er, Tm, Yb and Lu.

8. The flat-panel display according to claim 6 or 7, wherein said back substrate is flat; said front substrate has an edge frame integrally formed at a peripheral edge thereof; and an end face of said edge frame and said back substrate are sealed through a sealing material.

9. The flat-panel display according to claim 6 or 7, comprising:
a frame glass at each peripheral edge of said back substrate and said front substrate, said frame glass being a different body from said back substrate and said front substrate,
wherein said back substrate, said front substrate and said frame glass are sealed through a sealing material; and
wherein said frame glass is a glass material that contains SiO₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

10. The flat-panel display according to claim 6 or 7, comprising:
a frame glass at each peripheral edge of said back substrate and said front substrate, said frame glass being a different body from said back substrate and said front substrate,
wherein said back substrate, said front substrate and said frame glass are sealed through a sealing material; and
wherein said frame glass is a glass material that contains SiO₂ as a main component and contains from 1% to 10% by weight of at least one selected from a group consisting of La, Sc, Y, Ce, Pr, Nd, Pm, Sm, Eu, Gd, Tb, Dy, Ho, Er, Tm, Yb and Lu.

11. The flat-panel display according to claim 6 or 7, comprising:
a spacer inside a vacuum container formed by sealing said back substrate and said front substrate, said spacer being for maintaining a spacing between said back substrate and said front substrate,
wherein said spacer, said back substrate and said front substrate are sealed through a sealing material; and
wherein said spacer is a glass material that contains SiO₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

12. The flat-panel display according to claim 6 or 7, comprising:
a spacer inside a vacuum container formed by sealing said back substrate and said front substrate, said spacer being for maintaining a spacing between said back substrate and said front substrate;
wherein said spacer, said back substrate and said front substrate are sealed through a sealing material; and
wherein said spacer is a glass material that contains Sio₂ as a main component and contains from 1% to 10% by weight of at least one selected from a group consisting of La, Sc, Y, Ce, Pr, Nd, Pm, Sm, Eu, Gd, Tb, Dy, Ho, Er, Tm, Yb and Lu.

13. A flat-panel display comprising:
a vacuum container according to claim 6 or 7; and
a filter provided at a front substrate side of said vacuum container,
wherein said filter is a glass material that contains SiO₂ as a main component and contains from 1% to 20% by weight of at least one selected from a group consisting of La, Sc, Y, Ce, Pr, Nd, Pm, Sm, Eu, Gd, Tb, Dy, Ho, Er, Tm, Yb and Lu.

14. A flat-panel display comprising:
a vacuum container according to claim 6 or 7; and
a filter provided at a front substrate side of said vacuum container,
wherein said filter is a glass material that contains SiO₂ as a main component and contains from 1% to 10% by weight of at least one selected from a group consisting of La, Sc, Y, Ce, Pr, Nd, Pm, Sm, Eu, Gd, Tb, Dy, Ho, Er, Tm, Yb and Lu.

15. The flat-panel display according to claim 13, wherein said front filter is a laminate formed by laminating two or more sheets of glass material through an adhesive layer.

16. The flat-panel display according to any of claims 1-4, 6 and 7, wherein said glass material has a composition, in terms of oxides, of from 40% to 80% by weight of SiO₂, from 0% to 20% by weight of B₂O₃, from 0% to 25% by weight of Al₂O₃, from 5% to 20% by weight of R₂O, where R denotes an alkali metal, from 5% to 25% by weight of R′O, where R′ denotes an alkaline-earth metal, and from 1% to 20% by weight of Ln₂O₃, where Ln denotes at least one selected from a group consisting of La, Sc, Y, Ce, Pr, Nd, Pm, Sm, Eu, Gd, Tb, Dy, Ho, Er, Tm, Yb and Lu.

17. The flat-panel display according to any of claims 1-4, 6 and 7, wherein said glass material has a composition, in terms of oxides, of from 50% to 70% by weight of SiO₂, from 5% to 25% by weight of Al₂O₃, from 7% to 20% by weight of R₂O, where R denotes an alkali metal, and from 1% to 10% by weight of Ln₂O₃, where Ln denotes at least one selected from a group consisting of La, Y, Gd, Yb and Lu.

18. The flat-panel display according to any of claims 1-4, 6 and 7, wherein said glass material contains a coloring component.

19. The flat-panel display according to any of claims 1-4, 6 and 7, wherein said substrate comprises at least one selected from a group consisting of a layer for adjusting electrical properties of a discharge electrode and a layer for adjusting optical properties.

20. The flat-panel display according to any of claims 1-4, 6 and 7, wherein said glass material comprises a layer for reducing scattering of said glass material when it is broken.

21. The flat-panel display according to any of claims 1-4, 6 and 7, wherein said glass material has a density of 2.6 g/cm³ or less.

22. The flat-panel display according to any of claims 1-4, 6 and 7, wherein said glass material has a transition temperature of 450° C. or higher.

23. The flat-panel display according to any of claims 1-4, 6 and 7, wherein said glass material has a transition temperature of 600° C. or higher.

24. The flat-panel display according to any of claims 1-4, 6 and 7, wherein said glass material has a coefficient of thermal expansion of from 70×10⁻⁷/° C. to 90×10⁻⁷/° C.

25. The flat-panel display according to any of claims 1-4, 6 and 7, wherein said glass material has a coefficient of thermal expansion of from 80×10⁻⁷/° C. to 90×10⁻⁷/° C.

26. The flat-panel display according to any of claims 1-4, 6 and 7, wherein said glass material has a Young's modulus of 80 GPa or more.

27. The flat-panel display according to any of claims 1-4, 6 and 7, wherein said glass material has a specific Young's modulus obtained by dividing Young's modulus by density of 30 GPa/(g/cm³) or more.

28. The flat-panel display according to any of claims 1-4, 6 and 7, wherein said glass substrate has a thickness of 2.5 mm or less.

29. The flat-panel display according to any of claims 1-4, 6 and 7, wherein said glass substrate has a thickness of 2.0 mm or less.

30. An image display panel for a flat-panel display comprising, at least, two substrates and a light-emitting part provided between said substrates, wherein said image display panel is used for the flat-panel display according to any of claims 1-4, 6 and 7.
